(19) United States
(12) Patent Application Publication
(10) Pub. No.: US 2012/0126450 A1
(43) Pub. Date: May 24, 2012

(54) Method And Device For Manufacturing An Impression Of A Person-Specific Contact Surface For Sitting Orthosis

(75) Inventors: Andries Van Berkum, Nijmegen (NL); Kamiel Reinier Zale Geenen, Nijmegen (NL); Bernard Jan Kamp, Oldenzaal (NL); Simon Alexander Verheul, Nijmegen (NL)

(73) Assignee: PERTEON SEATS B.V., Oldenzaal (NL)

(21) Appl. No.: 13/322,987

(22) PCT Filed: May 27, 2010
(86) PCT No.: PCT/NL10/50316

§ 371 Date: Feb. 8, 2012

(30) Foreign Application Priority Data
May 29, 2009 (NL) 2002944

(51) Int. Cl. B29C 33/42

(52) U.S. Cl. 264/222; 425/2

(57) ABSTRACT

The invention relates to a method for manufacturing an impression of a person-specific contact surface for a sitting orthosis, comprising of providing a first flexible holder in which a quantity of separate particles is present, bringing the contact surface into the desired form by bringing the person into supporting contact in a desired position with at least the first flexible holder, fixing the contact surface by applying an underpressure in the flexible holder, removing the person after applying an underpressure in the flexible holder and making an impression of the contact surface, wherein an overpressure is applied in the at least one first flexible holder during forming of the contact surface. The invention also relates to a device for manufacturing a person-specific impression of a contact surface for a sitting orthosis.

The present invention relates to a method for manufacturing a person-specific impression of a contact surface of a sitting orthosis. The invention also relates to a device for manufacturing a person-specific impression of a contact surface of a sitting orthosis.

A sitting orthosis is a chair for supporting a person with an anomalous anatomy in a comfortable position. A known anatomical abnormality for which a sitting orthosis is applied is a curvature of the spine, also referred to as scoliosis or kyphosis. The contact or support surface with which such a sitting orthosis supports the person positioned therein is usually made to measure for the person, whereby a contact surface is obtained with a pressure distribution which is as homogeneous as possible for the person. Not only can the person hereby be accommodated in the sitting orthosis with a good sitting comfort, the body parts of the person also enjoy a good support, this preventing a deterioration in the anatomical abnormality in the longer term.

A prior art method for manufacturing a person-specific impression of a contact surface for a sitting orthosis comprises of: providing at least one first flexible holder in which a first collection of separate particles is present, forming the impression for the contact surface by bringing the person into supporting contact in a desired position with at least the first flexible holder, fixing the contact surface by applying an underpressure in the at least one first flexible holder and then allowing the person to leave the at least one first flexible holder.

A drawback of this known method is that a person-specific impression is obtained which corresponds to only limited extent to the shape of the body of the person. This is to the detriment of the comfort, the support and the sitting stability of the person. It is also important that the pressure exerted on the person by the sitting orthosis is as constant as possible in order to prevent medical complications.

The object of the present invention is to provide a method and a device for manufacturing an impression of a person-specific contact surface for a sitting orthosis and an improved device, wherein the above stated drawbacks are at least partially obviated.

The present invention provides for this purpose a method of the above stated type, wherein an overpressure is applied in the at least one first flexible holder during forming of the contact surface.

A person-specific impression of the contact surface is hereby obtained which is formed more around the body of the person. This is because, owing to the overpressure, the volume of the holder increases to some extent, and the usually spherical or at least convexly rounded particles of substantially the same size present in the holder are given the opportunity to flow so that the holder becomes flexible and adjusts more easily to the shape of the person. The volume of the holder has after all increased due to the overpressure applied in the holder, which improves the flow of the particles. The particles can hereby be displaced in simple manner with less effort. These measures make it possible to more easily place particularly heavy body parts in a desired position. This is because the particles pressed together by a heavy body part have the possibility of displacing relative to each other.

The separate particles here have a coefficient of friction which enables a free movement of the particles when an overpressure is applied and which sufficiently fixes the shape of the holder in the case of an underpressure, even if the person moves, for instance when he/she leaves the holder. The underpressure causes the particles to be pressed together, and the particles thus take up a fixed relative position due to their friction. For easy deformability it is also important that the particles have a low density so that the weight of these particles has a negligible influence on the deformability of the holder. The quantity of particles must be chosen so that the required effects are achieved; the holder will here generally be filled with particles when the pressure inside and outside the holder is the same.

It is further possible to form the possibly peripheral parts of the flexible holders as desired. The peripheral parts of the at least one flexible holder are kneadable if an underpressure is applied with a value lower (i.e. closer to the air pressure) than the value of the underpressure for fixing the flexible holder. The peripheral parts of the holder can hereby be formed more easily round extreme body parts of the person.

In a practical embodiment the at least one first flexible holder takes the form of a cushion and the at least one first flexible holder is initially placed in a carrier in the form of a chair. By placing the at least one holder in a carrier the person comes to sit higher relative to a ground surface, which results in a more comfortable working posture for the person carrying out the measurement. The flexible holders embodied as cushions are also supported by the carrier, whereby the cushions remain better positioned during the measurement and the accuracy of the contact surface is improved. The carrier is particularly displaceable in the height relative to a ground surface, whereby the person carrying out the measuring can adjust the position of the carrier.

The seat of a sitting orthosis usually lies in a substantially horizontal plane and the backrest in a plane differing only little from the vertical. In a first embodiment the carrier is placed in a desired orientation for the person by positioning at least one support element of the carrier. The most comfortable possible sitting position for the person can in this way be obtained, with a more homogeneous pressure distribution. The term positioning can here comprise a rotation about an imaginary or physical axis. It can be desirable for a person with an anatomical abnormality to place for instance the seat and the backrest of the sitting orthosis in a more horizontal orientation, whereby the supporting surface increases and the local pressure decreases. This improves the comfort for such persons and can result in a reduced deterioration in the anatomical abnormality of the person.

Three holders are preferably used when performing the method. The first holder is here then placed on the seat surface of the carrier, the second holder adjacently of the lower part of the backrest of the carrier and the third holder adjacently of the upper part of the backrest of the carrier. The use of three holders prevents the granular particles ‘subsiding’ inside the holder and coming to lie largely on the seat surface, so that an insufficient number is available to form a fitting contact surface at the upper part of the back. This otherwise by no means precludes the three holders being fixedly connected or connectable to each other.

The carrier and the support elements can be formed in various ways. It is attractive for one of the support elements to form a seat surface and for the other to form support elements for respectively the lower back and upper back. The carrier can also comprise support elements for supporting the calves of the person. Use can then also be made of an additional cushion for manufacturing an impression of a contact surface of the calves of the person.

The person is preferably allowed to move to some extent during the forming of the impression for the contact surface, wherein an overpressure is applied in the at least one first flexible holder. The person can hereby sink further into the material particles, whereby an improved, i.e. at least a deeper impression can be obtained. The stability of a thus obtained impression is thus further improved in that the person lies deeper in the particles.

It is further attractive for three or more holders to be applied, starting with the lowest holder which is usually placed on the seat surface. This holder does after all have the greatest influence on the position of the person. As soon as the form of this holder is fixed, the position of the person is largely fixed, so that the adjustment of the shape of the higher lying holders does not disrupt that of the lowest one.

In yet another embodiment the method is characterized by forming an impression for a work surface for the person, comprising of placing an additional flexible holder with material particles on a part of the body of the person who is brought into supporting contact in a desired position with at least the first flexible holder; forming the impression for the work surface by bringing a measuring plate into supporting contact in a desired position with the additional flexible holder; and fixing the impression for the work surface by applying an underpressure in the at least one additional flexible holder. An impression of a work surface in a desired position for the person can in this way be obtained in simple manner. The work surface can particularly also be tilted more forward or rearward here. If an underpressure is applied in the first flexible holder, the relative orientation of the work surface and the person-specific impression for the contact surface of the sitting orthosis is improved. This is because the person-specific impression for the contact surface of the sitting orthosis is then more fixed and the person is thereby better stabilized. The measuring plate can here be an individual measuring plate, such as a model for the work surface, but can also be the eventual work surface for the person. An impression for a headrest for the person can also be manufactured in comparable manner.

During the forming of the impression for the work surface an overpressure is particularly applied here in the at least one additional flexible holder. This facilitates positioning of the work surface in that the particles can flow in the additional flexible holder.

For the further specific forming of the work surface for the person, a contour, and particularly a contour line, of the stomach of the person is measured in order to form an edge facing toward the person of a work surface for the person. The edge of a work surface for the person facing toward the person is hereby better modified to the anatomy of the person, this further improving the functionality of the sitting orthosis. Due to a better fitting of the work surface to the stomach of the person the work surface provides an improved option for supporting for instance an arm or hand of the person. The risk of objects falling between the stomach and the work surface is hereby also reduced.

In another embodiment the volume of the flexible holder is slightly greater than the volume of the particles at an atmospheric pressure in the holder. This can improve the flow behaviour of the particles in the flexible holder, whereby not only can a person-specific impression of the contact surface for the sitting orthosis be obtained in simple manner, but wherein the person can also sink further into the particles. The flexible holder can also be manufactured from a substantially elastic material. The volume of a holder manufactured from such a material can easily become larger at an overpressure in the holder, which likewise improves the flow of the particles. The elastic material particularly comprises a rubber such as latex.

In an advantageous embodiment a contour line of the edge of the contact surface for the sitting orthosis is arranged on the fixed contact surface, and coordinates of the contour line are then converted into digital form. The contour of the edges of the contact surface can hereby be digitized in efficient manner. Coordinates of the contour can later be used effectively for the purpose of finishing the sitting orthosis, for instance for the form of a covering of the sitting orthosis and for the attachment of the covering to the sitting orthosis.

A grid is also arranged on the fixed contact surface, and coordinates of nodes of the grid are then converted into digital form. The contact surface can hereby be digitized in efficient manner, after which further processing can take place. The grid is preferably an adaptive grid, which in this context is understood to mean that the distance between grid lines is measured over the surface of the impression of the contact surface. It is also the aim to have the outer grid lines coincide with contour lines. The mesh of the grid here preferably lies between 2×2 cm and 7×7 cm, and more preferably between 3×3 cm and 6×6 cm. Such a mesh is found to be a good compromise between arranging of the grid in a short time on the fixed contact surface and the accuracy of the representation of the grid of the contact surface. The mesh size is not precluded from being dependent locally on the degree of curvature of the surface.

An advantageous device for arranging such a grid comprises a handle, a wheel connected rotatably to the handle, a holder for a pen, wherein the holder of the pen is connected to the handle such that the pen is in contact with the wheel. A medium such as a washable ink or a paint for arranging the grid can hereby be arranged on the impression in simple manner using the wheel. The pen can particularly be urged under bias against the wheel. It has been found that arranging a grid using a wheel is not only simple but also results in an improved, i.e. more regular, line direction.

It is advantageous if use is made of a measuring element movable relative to the person-specific contact surface for a sitting orthosis for the purpose of converting coordinates of the grid into digital form, wherein the measuring element has a fixed part and a movable part and wherein the fixed part of the measuring element is placed on a fixed platform and the measuring element is adapted to convert into digital form the positional relation between the fixed part and the movable part of the measuring element. Such a method of converting the coordinates is simple and flexible. Elements between the movable part and the fixed part are preferably provided here with digital angle sensors.

In another embodiment the underpressure in the at least one first flexible holder is held between pre-known values during arranging of a grid on the fixed contact surface and the subsequent conversion of coordinates of the grid into digital form. The possible penetration of air into the flexible holder is hereby compensated if, due to the penetration of the air into the flexible holder, the underpressure prevailing therein comes too close to the ambient pressure, thereby reducing the risk of a change in form of the impression for the contact surface for the sitting orthosis. The penetration of air into the flexible holder can be caused in that the flexible holders are air-permeable or as a result of a leak in the flexible holder or in connecting means, such as a valve, for connecting the flexible holder to a pump. An excessive underpressure can otherwise also result in a change in form of the person-specific impression for the contact surface for the sitting orthosis, for instance due to contraction of the particles.

In another embodiment the method is characterized by measuring coordinates relative to the grid of at least one of the body parts of the person brought into supporting contact in a desired position with the at least one first flexible holder, selected from the group consisting of: elbow, wrist, calf, foot and head of the person, and subsequently converting the measured coordinates into digital form. These coordinates can for instance be used during further finishing of the sitting orthosis for the purpose of fixing support elements for these body parts to the sitting orthosis. In a practical manner the flexible holders are embodied here as cushions.

This measure can also be used for recording the coordinates of support elements for relevant body parts.

In another embodiment the method comprises of measuring patient-specific coordinates on the fixed impression of the contact surface for further finishing of the sitting orthosis. During further finishing of the sitting orthosis these coordinates can for instance be used for the purpose of attaching to the sitting orthosis at least an armrest and/or accessories for the person. The patient-specific coordinates can also comprise locations on the contact surface for indicating areas where a recess is desired in the contact surface. Such a recess results in a local pressure decrease and thereby to more comfort for the user, whereby a deterioration in the anatomical abnormality can be prevented in the longer term. Such areas are located particularly where the harder anatomical parts, such as bones, of the person present in a desired position in the sitting orthosis touch the contact surface.

The invention also relates to a device for manufacturing an impression of a contact surface adapted to the person for a sitting orthosis, comprising: a frame, support elements connected to the frame, at least one flexible holder which is provided with a quantity of separate particles and an air pump which can be connected to the interior of the flexible holder for applying an underpressure in the flexible holder for the purpose of fixing the impression, wherein the pump is likewise adapted to apply an overpressure in the flexible holder, and that the device comprises a switching device which can be connected to the pump and which is displaceable between a first position for applying an underpressure in the flexible holder and a second position for applying an overpressure in the flexible holder. An overpressure can in this way be applied in the at least one flexible holder in simple manner. For the advantages of applying an overpressure in the at least one flexible holder reference is made to the advantages already stated above of the method for manufacturing a person-specific impression of a contact surface for a sitting orthosis.

In a first embodiment the support elements are connected displaceably to the frame and the device comprises a reference element connected displaceably to the support elements and a measuring element which can be connected to the device, wherein the measuring element is adapted to measure the orientation of the reference element relative to the support elements. Because the support elements are connected to the frame for displacement about at least one axis with a component in the horizontal direction, the most comfortable possible sitting position for the person can be obtained, with the most homogenous possible pressure distribution. It can be desirable for a person with an anatomical abnormality to arrange the seat and the backrest of the sitting orthosis in a more horizontal orientation, whereby the supporting surface increases. This improves the comfort and can result in a limitation of the deterioration in the anatomical abnormality of the person. The desired orientation of the person in the sitting orthosis can differ from the main direction of the sitting orthosis. The person in a desired position in the sitting orthosis can thus be rotated laterally to some extent relative to the sitting orthosis, so that the person in a desired posture can then look forwards. This can generally be accommodated by the flexible holders, since the flexible holders can deform to a great extent. The support elements can also be connected to the frame for displacement about at least one substantially vertically extending axis. The impression is hereby also rotated relative to the frame, whereby greater deviations in the orientation can be accommodated.

The reference element and a measuring element which can be connected to the device, wherein the measuring element is adapted to measure, relative to the support elements, an orientation of the reference element known to a user, can advantageously be used to determine the orientation of the support elements relative to a pre-known reference. The reference element can for instance comprise a spirit level with which the orientation of the support elements relative to the horizontal and/or vertical can be determined after the support elements have been placed in a desired position. The reference element can be a mounting plate for the measuring element or a reference element separate from the measuring element, such as a measuring plate provided with at least a liquid. The reference element is particularly connected to a support element connected displaceably to the frame. After rotating a support element about an axis, for instance until the most comfortable possible sitting position for the person is obtained, a user can again rotate the reference element to an orientation of the reference plate known to the user, this orientation particularly being the horizontal plane.

The device preferably comprises a control device for applying a desired pressure in the at least one first flexible holder by means of the pump. The operation of the device can hereby be automated. The lower limit and upper limit of both the underpressure and overpressure can thus be set, and the control device is adapted particularly to operate the switching device. The underpressure and overpressure in the at least one flexible holder can hereby be applied and maintained automatically. The control device, the switching device and the pump are particularly adapted to apply desired and mutually differing overpressures and/or underpressures in the different flexible holders.

In a further embodiment the device comprises a footrest and headrest connected displaceably to the frame and the measuring element is adapted to measure specific coordinates of the headrest and footrest. The thus obtained coordinates can be used in further finishing of the sitting orthosis, wherein the sitting orthosis is provided with a footrest and headrest.

In a practical embodiment the first flexible holder preferably comprises at least two, and still more preferably at least three cushions, which cushions can each be connected to the pump. A person measuring the person-specific impression of a contact surface for a sitting orthosis can hereby position the necessary cushions relative to the support elements in simple manner and with less effort. The device particularly also comprises a cushion for manufacturing a person-specific impression of a contact surface for a work surface for the person. Cushions can also be present for making a person-specific impression of a contact surface for a headrest, a footrest and the like for the person.

The support elements are displaceable particularly in the height relative to the frame, wherein a seat surface is preferably displaceable between 460 and 860 mm relative to a ground surface. This results in an ergonomic working posture for a person measuring the person-specific impression of a contact surface for a sitting orthosis. The support elements can also be adapted to form the seat and backrest of the device, wherein the backrest and seat formed by the support elements are displaceable about at least one axis with a component in the horizontal direction. The advantages hereof have already been stated above. The depth of the seat can also be adjustable, as well as the angle between seat and backrest. The device for manufacturing a person-specific impression of a contact surface for a sitting orthosis hereby becomes very flexible in use. The support elements can further be adapted such that the lumbar setting (the lower back) is adjustable.

The present invention will be further elucidated on the basis of the non-limitative exemplary embodiments shown in the following figures. Herein:

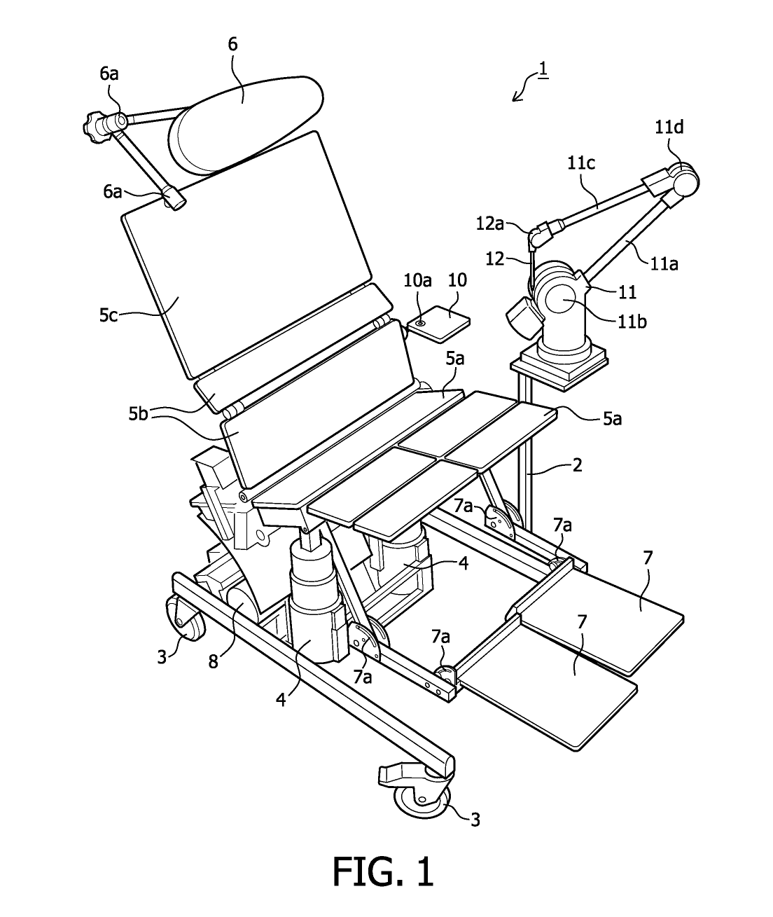

FIG. 1 shows a perspective view of a part of the device for manufacturing a person-specific impression of a contact surface for a sitting orthosis according to the invention;

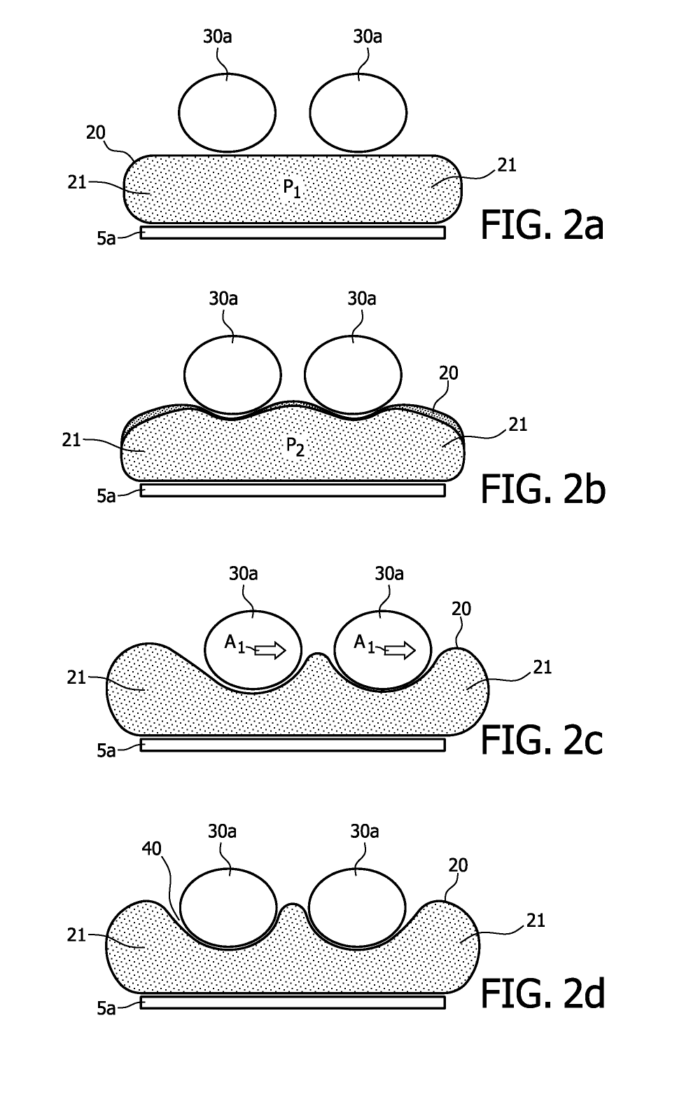

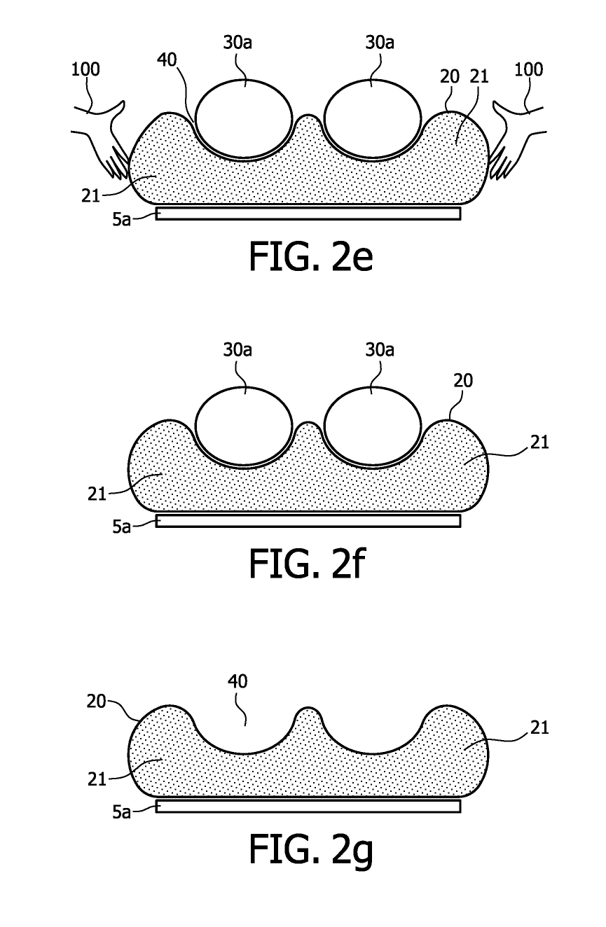

FIG. 2a shows a schematic sectional view of a flexible holder according to the invention, on which the person of whom an impression must be made is lying;

FIG. 2b shows a schematic sectional view of the flexible holder of FIG. 2a, wherein an overpressure is applied in the flexible holder;

FIG. 2c shows a schematic sectional view of the flexible holder of FIG. 2a, wherein the impression is formed by movement of the person;

FIG. 2d shows a schematic sectional view of the flexible holder of FIG. 2a, wherein an underpressure is applied in the flexible holder in the correct position of the person;

FIG. 2e shows a schematic sectional view of the flexible holder of FIG. 2a, wherein in the correct position of the person an underpressure is applied in the flexible holder and edges of the flexible holder are deformed;

FIG. 2f shows a schematic sectional view of the flexible holder of FIG. 2a, wherein an underpressure is applied in the correct position of the person such that the impression is fixed;

FIG. 2g shows a schematic sectional view of the flexible holder of FIG. 2a, wherein the person is removed from the flexible holder and the impression is formed;

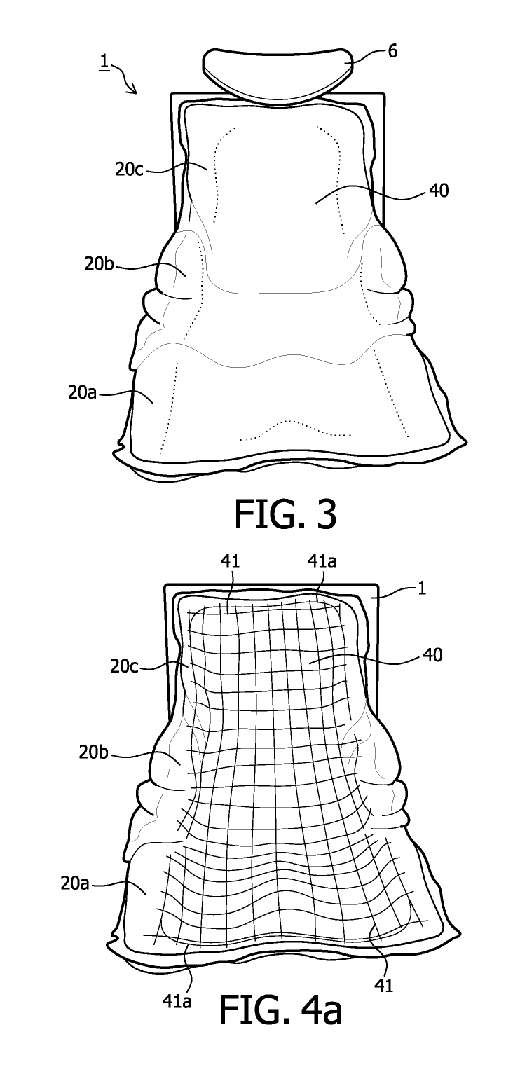

FIG. 3 shows a perspective view of the device of FIG. 1 provided with flexible holders, wherein the impression is fixed;

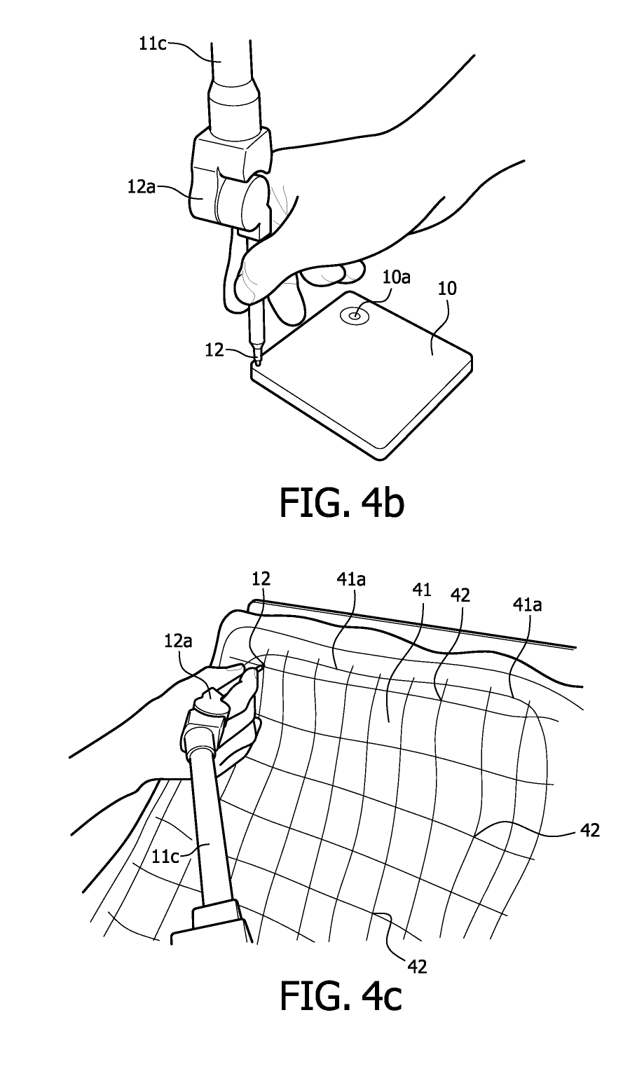

FIG. 4a shows a perspective view of the device of FIG. 3, wherein a grid pattern is arranged on the fixed impression;

FIG. 4b shows a detail view of the device of FIG. 4a, wherein the orientation of a reference plate is determined using a measuring element;

FIG. 4c shows a detail view of the device of FIG. 4a, wherein coordinates of the grid pattern are determined using a measuring element and converted into digital form; and

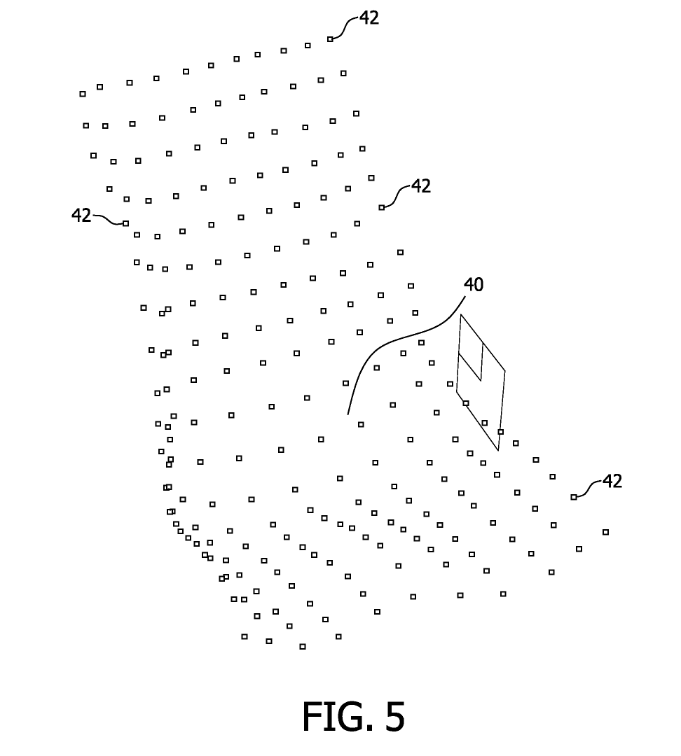

FIG. 5 shows a perspective view of the digitized, person-specific impression of a contact surface for a sitting orthosis.

FIG. 1 shows a perspective view of a device 1 for manufacturing a person-specific impression of a contact surface for a sitting orthosis. This device 1 comprises a frame 2 which is preferably provided with wheels 3. Support elements 5 are connected to frame 2 by means of linear drive elements 4 which extend in substantially vertical direction and which can be driven by an electric motor (not shown). Support elements 5 comprise plates for a seat surface 5a, plates for supporting the lower back 5b and plates for supporting the upper back 5c. Support elements (5a, 5b, 5c) are each displaceable relative to each other by drive means (not shown) which can be embodied as hydraulic cylinders. A headrest 6 is connected displaceably to the plates for supporting upper back 5c via fixable hinges 6a. Two footrests 7 are further connected displaceably to frame 2 via fixable hinges 7a. A carrier 9 is thus formed on which flexible holders (not shown in the drawing) are placed.

An air pump 8 is connected to frame 2 under the plates for a seat surface 5a. Air pump 8 can be connected to the mains supply by means of a cord with a plug. Air pump 8 and the flexible holders (not shown) are connected by means of air hoses (not shown) for feed of air out of or into the flexible holders. The device further comprises an intelligent control device (not shown in the drawing) connected to air pump 8, and a switching device, which are connected to the same cord.

A reference plate 10 is also connected to support element 5b for movement around a ball joint (not shown). The ball joint can be blocked in its movement using a clamping bolt (not shown), whereby the reference plate is fixed relative to support element 5b. Reference plate 10 is provided with a spirit level 10a. A measuring element 11 embodied as three-dimensional measuring arm is also connected to frame 2. The operation of device 1 is explained with reference to FIGS. 2-5.

FIG. 2a shows a schematic detail sectional view of device 1 of FIG. 1 which shows a flexible holder embodied as a cushion 20 and placed against support element 5a. Cushion 20 is manufactured from the elastic material latex. The cushion is provided with separate, substantially spherical material particles 21, which are manufactured from expanded polystyrene. Cushion 20 is connected to pump means 8 by a hose (not shown) (see FIG. 1). A person 30 for whom an orthosis must be manufactured has taken up position on the thus positioned holder 20. Legs 30a of a person 30 are brought into supporting contact with cushion 20. An underpressure P1 is applied in cushion 20. Because an underpressure P1 has been applied, the person 30 can take up position in device 1 in simple manner without cushions 20 being pushed away from a desired position. This is the starting point for the manufacture of an impression specific to this person of a contact surface for a sitting orthosis.

FIG. 2b shows a schematic detail sectional view of device 1 of FIG. 2a. An overpressure P2 is applied in cushion 20 using the switching device and pump means 8, whereby air is supplied to cushion 20. Because cushion 20 is manufactured from an elastic material it will stretch and thereby undergo an increase in volume. The particles 21 can hereby begin to flow, see FIG. 2b, and cushion 20 can be deformed. Legs 30a hereby sink further into cushions 20 due to the force of gravity supplemented by the movement of legs 30a of the person 30 in desired directions, as indicated by arrows A1 in FIG. 2c. Cushion 20 with material particles 21 hereby forms itself partially round legs 30a of the person 30 as shown in FIG. 2d. A contact surface 40 formed in the shape of cavities in cushion 20 is hereby obtained. When the person 30 has been placed in a desired posture, an underpressure P2 is once again applied in cushion 20. Contact surface 40 is hereby fixed to some extent in cushion 20. The underpressure P2 has a value such that, although contact surface 40 is fixed to some extent, a person (not shown) carrying out the measurement can still adjust the shape of cushion 20; cushion 20 is here still kneadable. This person can thus still adjust for instance the edges 20a of cushion 20 with his/her hands 100, as shown in FIG. 2e. When the person 30 is still lying in the desired posture and cushion 20 is given a desired shape, the underpressure in cushion 20 is further increased in that the pump pumps more air out of the cushion until the initial underpressure P 1 is restored. The contact surface of the cushion is hereby actually fixed, this being shown in FIG. 2f. The person 30 can now leave cushion 20 without contact surface 40 changing form, as shown in FIG. 2g. Although mention is made in this context of only one cushion 20 for the legs 30a of the person 30, a plurality of cushions 20 can be applied, wherein particles 21 are present in each of the cushions 20 and wherein each cushion is connected to pump means 8. A fixed contact surface 40 is hereby obtained which is modified to the body of the person 30.

FIG. 3 shows a perspective view of device 1 of FIG. 1 provided with flexible holders embodied as three cushions (20a,20b,20c), wherein contact surface 40 is fixed as a result of the underpressure P1 prevailing in cushions 20. Headrest 6 and footrests 7 (not shown here) are also placed in the correct position.

FIG. 4a shows a perspective view of device 1 of FIG. 3, wherein a grid pattern 41 is arranged in the impression 40 arranged and fixed in cushions (20a,20b,20c). The mesh of the grid is preferably about 4×4 centimetres over the surface of impression 40. This figure also shows clearly that support elements (5a,5b,5c) are rotated about an axis with a horizontal component, whereby the person 30 has taken up a more recumbent position.

FIG. 4b shows a detail view of the device of FIG. 4a. With the orientation of support elements (5a,5b,5c) of FIG. 4a desired for the person the reference plate 10 is moved while making use of spirit level 10a such that the reference plate extends in a horizontal plane. When reference plate 10 extends in a horizontal plane, reference plate 10 is fixed relative to support elements (5a,5b,5c) by blocking the movement of the ball joint (not shown) using a clamping bolt (not shown). Using a probe 12 of the measuring element the orientation of reference plate 10 is determined by measuring three points of reference plate 10 (see FIG. 4b). The coordinates of these three determined points of reference plate 10 are converted into digital form and stored in a memory. The coordinates of nodes 42 of grid 41 are then measured using probe 12 of measuring element 11 (see FIG. 4c). These coordinates are likewise converted into digital form and stored in a memory. Contour line 41a for indicating edges of the contact surface extends at a distance from probe 12 such that probe 12 cannot reach the whole contour line for measuring thereof. For this purpose support elements (5a,5b,5c) can be rotated in a relatively fixed position, after which the orientation of reference plate 10 fixed and thus co-rotated with support elements (5a,5b,5c) can be determined relative to the previously measured three points with reference plate 10 in the horizontal position, after which other nodes 42 of grid 41 can then be measured.

FIG. 5 shows a perspective view of the digitized, person-specific impression 40 of a contact surface for a sitting orthosis. The digital impression 40 is determined by coordinates 42 of grid pattern 41. Because the orientation of support elements (5a,5b,5c) is also determined, the orientation of impression 40 relative to the horizontal plane is also known. A digitized impression 40 is hereby obtained which can be used for further finishing of the sitting orthosis.

It will be apparent that numerous variations of the above described embodiments are possible within the scope of the invention as defined by the claims. It is thus possible for instance to combine the method for fixing the contact surface with another method for the converting the coordinates of the thus obtained contact surface to a digital file or to another form suitable for manufacturing therefrom an actual orthosis adapted to the person. It is otherwise also possible to combine the method for converting a fixed contact surface into digital form with another method for fixing a contact surface.

1. A method for manufacturing an impression of a person-specific contact surface for a sitting orthosis, comprising the steps of:
providing at least a first flexible holder in which a quantity of separate material particles is present;
bringing the contact surface into the desired form by bringing the person into supporting contact in a desired position with at least the first flexible holder;
fixing the contact surface by applying an underpressure in at least the first flexible holder;
removing the person after applying an underpressure in at least the first flexible holder; and
making an impression of the contact surface,
wherein an overpressure is applied in at least the first flexible holder during forming of the contact surface.

2. The method as claimed in claim 1, wherein the at least one first flexible holder takes the form of a cushion and that the at least one first flexible holder is initially placed in a carrier in the form of a chair.

3. The method as claimed in claim 2, wherein the carrier is placed in an optimal position for the person by positioning at least one support element of the carrier.

4. The method as claimed in claim 1, wherein three flexible holders are provided, in each of which material particles are arranged.

5. The method as claimed in any of the claim 1, wherein by allowing the person to move during the forming of the contact surface, wherein an overpressure is applied in the at least one first flexible holder.

6. The method as claimed in claim 1, wherein by forming an impression of a work surface for the person, comprising of placing an additional holder with material particles on a part of the body of the person who is brought into supporting contact in a desired position with the at least one first flexible holder; forming the impression of the work surface by bringing a measuring plate into supporting contact in a desired position with the additional flexible holder; and fixing the impression of the work surface by applying an underpressure in the at least one additional flexible holder.

7. The method as claimed in claim 6, wherein during the forming of the impression for the work surface an overpressure is applied in the at least one additional flexible holder.

8. The method as claimed in any of the claim 1, wherein by measuring a contour of the stomach of the person in order to form an edge facing toward the person of a work surface for the person.

9. The method as claimed in any of the claim 1, wherein by arranging on the fixed contact surface a contour line representing the edge of the contact surface for the sitting orthosis and subsequently incorporating coordinates of the contour line into the impression.

10. The method as claimed in claim 1, wherein by arranging a grid on the fixed contact surface and then converting the coordinates of the nodes of the grid into digital form.

11. The method as claimed in claim 10, wherein the coordinates of the nodes of the grid arranged on the fixed contact surface are converted by means of a measuring element with a fixed part and a movable part, wherein the fixed part of the measuring element is placed on a fixed platform and the measuring element is adapted to convert into digital form the positional relation between the fixed part and the movable part of the measuring element.

12. The method as claimed in claim 10, wherein by holding the underpressure in the at least one first flexible holder between pre-known values during arranging of a grid pattern on the fixed impression of the contact surface and the subsequent conversion of coordinates of the grid into digital form.

13. The method as claimed in claim 10, wherein by measuring relative to the grid the coordinates of at least one of the body parts of the person brought into supporting contact in a desired position with the at least one flexible holder, selected from the group consisting of: elbow, wrist, calf, foot and head of the person, and subsequently converting the measured coordinates into digital form.

14. The method as claimed in claim 10, wherein by measuring the coordinates relative to the grid of support elements for at least one of the body parts of the person brought into supporting contact in a desired position with the at least one flexible holder, selected from the group consisting of: elbow, wrist, calf, foot, heel and head of the person, and subsequently converting the measured coordinates of the support elements into digital form.

15. The method as claimed in any of the claim 10, wherein by measuring patient-specific coordinates on the fixed impression of the contact surface for further finishing of the sitting orthosis.

16. A device for manufacturing a person-specific impression of a contact surface for a sitting orthosis, comprising:
a frame;
support elements connected to the frame;
at least one flexible holder which is provided with a quantity of separate material particles; and
pump means which can be connected to the interior of the at least one flexible holder for applying an underpressure in the flexible holder for the purpose of fixing the impression,
wherein the pump means are likewise adapted to apply an overpressure in the flexible holder, and that the device comprises a switching device which can be connected to the pump means and which is displaceable between a first position for applying an underpressure in the flexible holder and a second position for applying an overpressure in the flexible holder.

17. The device as claimed in claim 16, wherein the support elements are connected to the frame for rotation about an axis extending substantially in a horizontal direction, and that the device comprises a reference element connected displaceably to the support elements and a measuring element which can be connected to the device, wherein the measuring element is adapted to measure an orientation of the reference element known to a user relative to the support elements.

18. The device as claimed in claim 16, wherein the device comprises a control device for applying a desired pressure in the at least one first flexible holder by means of the pump means.

19. The device as claimed in claim 17, wherein the device comprises a footrest and headrest connected displaceably to the frame and that the measuring element is adapted to measure specific coordinates of the headrest and footrest.
